(19) United States
(12) Patent Application Publication
(10) Pub. No.: US 2022/0343006 A1
(43) Pub. Date: Oct. 27, 2022

(54) SMART MEDIA PROTOCOL METHOD, A MEDIA ID FOR RESPONSIBILITY AND AUTHENTICATION, AND DEVICE FOR SECURITY AND PRIVACY IN THE USE OF SCREEN DEVICES, TO MAKE MESSAGE DATA MORE PRIVATE

(71) Applicant: André Augusto CEBALLOS MELO, São Paulo (BR)

(72) Inventor: André Augusto CEBALLOS MELO, São Paulo (BR)

(21) Appl. No.: 17/729,300

(22) Filed: Apr. 26, 2022

(30) Foreign Application Priority Data
Apr. 26, 2021 (BR) 10 2021 007869 3
Apr. 26, 2021 (BR) 10 2021 007899 5
Apr. 26, 2021 (BR) 10 2021 007907 0

(51) Int. Cl. G06F 21/62; G06F 21/60

(52) U.S. Cl. CPC G06F 21/62; G06F 21/602

(57) ABSTRACT

A new technology for responsibility and authentication to make message data more secure, enhancing privacy and increasing encryption by taking into account brain activity and its visual perception, for security and privacy in the use of screen devices, which enhance information security and privacy by taking into account brain activity and its visual perception in the use of screen communication devices in such a way that visual information does not exist until observed. The result is private screen filters having an encryption polarization mode through a tokenization system designed to be arbitrary information by adding a second layer of encryption, where the interface image information fuses from layers, so as to increase the privacy and security of the information presented on the screen for people working with confidential data, providing a privacy shield, so the information can only be viewed on a screen using the encryption polarization filter.

### FIELD

This invention relates to a new device and a new smart media protocol method, a media ID as new technology for responsibility and authentication to make message data more secure, enhancing privacy and increasing encryption by taking into account brain activity and its visual perception, for security and privacy in the use of screen devices, which enhance information security and privacy by taking into account brain activity and its visual perception in the use of screen communication devices such that visual information does not exist until observed. Said method and device result in private screen filters having an encryption polarization mode through a tokenization system designed to be arbitrary information by adding a second layer of encryption, where the interface image information fuses from layers, so as to increase the privacy and security of the information presented on the screen for people working with confidential data, providing a privacy shield, so the information can only be viewed on a screen using the encryption polarization filter, so that anyone who tries to obtain screen recorders or peek aside will only see a dark screen.

### BACKGROUND

Today everything is editable and publishable by almost anyone. Now we find ourselves overwhelmed by an enormous abundance of media. And we enter a period that revolves around media reliability to solve (lose) information overload. A protocol to change the way media content today is being created, distributed and consumed is needed. Meet the emerging needs for transparency, responsibility and auditing at a very timely time.

The Media ID Concept is an Intelligent Media Protocol, as a shared accounting media authenticity tool.

A digital signature scheme in a distributed ledger that can be marked as hidden patterns invisible to human senses embedded in a digital media or in a simple form an online lossy compression media source record database system. A media recognition system to critically evaluate information to detect real and fake news. Digital Certification merged into the media as an intelligent watermark by marking metadata/information as a machine-readable encoded layer linking the metadata to the source of the media. Marking data modification of a media to block or pass a given set of spatial or geometric frequency pattern components. Media Signature Algorithm Provides a layer of media validation and security to verify the authenticity of digital media. A valid digital signature where prerequisites are met gives the media consumer a strong reason to believe that the message was created by a known sender (authentication) and that the message was not changed in transit (integrity). Machine reading verification and validation by detecting manipulated/non-original media (synthetic and deeply false media) disguised advertising and political deception in digital media. An automatic media identity detection using Fragment (string) matching algorithms for media source and creators' responsibility to ensure reliable and traceable production media standards.

Standard Certification for Media Source and Creator Responsibility As an important tool to improve the distinction of trusted media content and to give society confidence over the media provider. Aggregate data into digital media collectively by providing greater visibility and integrating that data into a wide range of media analytics.

As the common Internet user has Internet protocol (IP) addresses, the digital media must have an identification for responsibility to meet real social needs. Media misinformation can and should be held accountable for its own merits not dismissed as the inevitable by-products of the deepfake algorithm.

Improve media transparency for news reports, entertainment and social responsibility and sustainability information. Addressing the problem with fake news and misinformation. Identify the advertisements and political propaganda disseminated as informational means. Fighting misinformation by dispelling rumors of false news and messages of hatred and division.

Several additional uses can be cited, such as: avoiding copying in the media and illegal distribution, identifying copyright infringements. Media player with digital signatures automatically generated water in real time marking media consumption. A streamed media may generalize a user's subscription when played to specific user views. A blockchain technology to prevent copying of images and illegal distribution. Smart contract watermark with sub-item patterns adding a tonal variation in the image or a layered noise over an audible stimulus that humans cannot feel marking the currently logged in users and their license types;

Assemble film and music distribution strategies, working closely with the music industry, film operators and distributors to prevent and detect illegal recordings. The watermark in movies and music allows pirated copies to be traced back to the source through distributed accounting technology.

Provide information retrieval on the web as a reliable and alternative search engine, with an Intelligent Media Index for search engines to help generate more reliable search results. A basis for a search tool beyond the main search engines saturated by fake news user manipulation conspiracy theories advertising and propaganda. Current search engines are agnostic as to content and the content creator generally do not feel responsible for inappropriate content or copyright infringements. The goal was to facilitate the production and distribution of content. They weren't about the truthfulness of the content itself.

Verify emerging trends for Legal and Compliance, adding value to successful effectiveness and implementation of new laws and compliance needs. (e.g., Australia proposed the News Media Trading Code law)

Use augmented reality, this innovation can also be used to provide augmented reality experiences as a data representation for mobile augmented reality.

Use the user's Friendly App, where the user verifies a media with a smartphone and authentication is performed by the smartphone that contacts the server.

Use in Smart Media contracts, which is another area of potential use is the concept of smart contracts for copyrighted works. In a distributed ledger that is designed to automate certain acts like copying the image or sharing it on the Internet. This means that a user will generally need the permission of the copyright owner (s) if they want to distribute content as a media model strategy that means paid media wins shared and owned by them.

There is a lot of pessimism about social media damage providing a platform for political conspiracy theories and digital surveillance of our smartphones. The social media platform plays a key role in amplifying hate and conspiracies they distort and exploit the ability of the open internet to connect people with similar interests. When harmful content appears in them, a huge wave of false and misleading information appears. Deepfake reveals the weaknesses of the Internet. Prevention is the best protection against deepfake and harmful but compelling content (such as misinformation conspiracy theories). It's time for people to track down the media they consume. The goal is to empower people with information so they can make better decisions for reliable media consumption.

The content creator is marked on the media with a digital certificate to ensure the validity of the original media versus synthetic media (e.g., photos videos or audio files manipulated by artificial intelligence, AI). A machine-readable signature for media ID highlighting key features of trusted source information. A tool for media consumers to look at media features to help differentiate trusted sources from those that are not instead of basing their trust on just one piece of information. Evaluating the credibility of written communication video sound graphics and other media formats

### SUMMARY

The smart media protocol method, a media ID for responsibility and authentication, and device for security and privacy in the use of screen devices, to make message data more private, object of this invention, is applied to any branches of operation where screen devices are used, that is, smartphones, computers, notebooks, any device that uses screen displays, more specifically to be used by people who use these devices and need to preserve the information made available on the screen from third parties.

The smart media protocol method, a media ID for responsibility and authentication, and device for security and privacy in the use of screen devices, to make message data more private, object of this invention, aims to enhance privacy by increasing encryption in the brain and visual perception so that visual information does not exist until it is observed, providing a privacy shield for people working with sensitive data, and empowering vulnerable people against disinformation, deepfake, political advertisements, and propaganda disclosed as information media.

It further aims to offer a digital signature of the media creator/publisher to media consumers using distributed accounting technology as a blockchain service to track digital media, bring traceability and responsibility, and an intelligent media protocol that enables a connection between consumers and content creators, as well as new means of creating and publishing media, while empowering the public to decide which media is reliable (it should allow them to make better decisions as long as they are able to use the information they have received).

Today, everything can be created, edited and published by almost anyone. Now we find ourselves overwhelmed by an enormous abundance of media. And we enter a period that revolves around media reliability to solve (lose) information overload. A protocol to change the way media content today is being created, distributed, and consumed. Meet the emerging needs for transparency, responsibility and auditing at a very timely time.

High-tech manipulation trying to pass for real with the malicious intention of misinforming people by deceiving unsuspecting viewers is very common. People tend to jump to conclusions and that makes them even more confused. The fact that deepfakes are generated by AI that can continue to learn makes it inevitable that they outperform conventional detection technology. Another way to approach the different perspective problem from a different point of view. Identifying reliable information. Validate media strategies to provide more information more clarity and ensure that they continue to meet the needs of society. The identifier enables transparency and provides a global media validation directory available to the public by the registered content creators themselves. This tool will allow the user to investigate the evidence and detect possible traces of tampering or other types of inconsistencies. Know who is who and who owns who is critical to transparency and security in information sharing. It allows the user to evaluate whether the information is from a known media by observing the date of publication who wrote the content and whether the author is reliable.

Many distinct types of metadata can be tagged. Descriptive metadata is descriptive information about a resource, it is used for discovery and identification, which includes elements such as title, abstract, author and keywords, reports on image modification and editing, means of creating the data, purpose of the data, time and date of creation, creator or author of the data, location on the computer network where the data was created and the source of the data

Average ID (Smart Average) as a certificate of reality. In a first essential step is simply to raise public awareness of the possibilities and dangers of deepfakes. Informed citizenship is a crucial defense against widespread disinformation. The certification support framework should also be responsible for maintaining an updated media database, revocation information on the certificates issued, indicating whether the certificates are still valid. Providing information through media certificate status.

How to embed media with digital certificates (Media ID)? New uses of blockchain and digital accounting (DLT) technologies, designed to be tamper-resistant and to create definitive and immutable digital media records. Content creator linked to your works, but the nature of that link and its function as the source of a creator's authority over your digital content work, including video, photographs, graphics, audio, images, written articles, and visual arts.

A digital recording of an interference pattern that uses as an example a diffraction to reproduce a tagged metadata. Theory of Fractal Information:

A user can obtain valid information by avoiding fake news. A cloud-based blockchain database as a source for validation of markup source media and relevant information (for example whether or not creator history has been reviewed). A database with privacy and encryption control providing a fast and reliable way to assess the reliability and responsibility of your media content. It enables fast, real-time media processing. It would recognize patterns the same way a compression program works. Before a media creator uploads metadata files, they must have an account name and password. Media is not exported as a readable file format (cannot be processed for data viewing). Data is processed securely as metadata.

One idea to consider is the use of fractal information theory (fit) to calculate using mathematical sets that exhibit a repeat pattern displayed on all scales. Write metadata as geometric shapes or fractal beat added to a sound. The main lesson here is that no matter how you cut/segment a video or image or how much you “enlarge” the fractal, the patterns you see repeat themselves. The data may also be merged using boundary effects as observed between the array and linear interference patterns as the principles of holographic data storage. Not interfering with visual and auditory perception and other properties of the original media, the recording will be invisible to the human eye and not audible to the human ear. Unintelligible to humans. It is a coding of the metadata as an interference pattern of variations in the opacity, density, or surface profile of the media (e.g., subtle background variation or histogram). Or simply develop databases for online information retrieval as a service to track digital media and bring traceability.

This solution gives the media content and creator a digital identity as a package. The metadata stored by the database is saved permanently and cannot be changed. It can be added later, but you can't delete what's already there. This connection between the media itself and its creator/origin accessible on the blockchain is at the heart of what makes this solution different from everything that comes before it. Public information about the media, stored on the blockchain, becomes available to the user. It protects the content from tampering and improves legitimacy by displaying what the creator intended. Once the fingerprint is attached to the digital media, this data cannot be exchanged for a forgery. Loading a media and storing its metadata/fingerprint in a database, the application can help identify a media using data recognition power, making it easy to reference the record on the blockchain and find the truth (presence of sound, videos, written text and altered images with artificial intelligence). It also means that copiers will not be able to record false data related to this work. An important and dangerous new phenomenon in AI: deepfakes.

Deepfake technology allows anyone with a computer and an Internet connection to create realistic photos and videos of people saying and doing things they didn't really say or do. Due to the broad accessibility of technology, such images could be created by anyone: state-sponsored actors, political groups, lonely individuals. However, the biggest threat is the potential for deepfakes to be used in political disinformation campaigns. It can be even more dangerous in developing countries where digital literacy is more limited. In that case, you could actually impact how society would react. The emergence of deepfakes will make it increasingly difficult for the public to distinguish between what is real and what is false. The recent rise in fake news has raised fears that we are entering a “post-truth” world. In a world where seeing is no longer believing.

Over time, this will prevent people from attempting to falsify the media or campaign for disinformation. In reality, however, technology will only be part of the solution. This is because deepfakes will likely improve faster than detection methods. Humans and computers must work together as cooperative systems in an effort to combat disinformation.—Fake tech. To detect altered media that could generate political misinformation, corporate sabotage, or cyberbullying. A proactive action against disinformation, empowering the vulnerable population against disinformation. With each passing day society spends more time online, it's time to clean the room for a better life. Prevention and reliable information are the best protection against deepfake.

Can you imagine why in the world that intruder just got a spyware that has the screen logger? The simple answer is because all of this happens on someone's screen. That doesn't happen on the intruder's premises. It prevents your valuable and sensitive information from being stolen by hackers. The attacker on the other hand can collect this data stream using video recording from the compromised computer screen but cannot reconstruct the ex-filtered information using image processing techniques. Individuals sitting in front of the monitor can clearly see the data on the screen. On the other hand, the intruder does not know that there is a cross-image token associated with the session ID. Cross-imaging layer for graphical user interface formation. Add a layer of security to the screenshot while creating image privacy and reducing or eliminating knowledge of information on a given screen. This will limit incidental exposure of personal information by screenshots. It is logically isolated and segmented from data processing systems and applications that previously processed or stored sensitive user interface data.

Thanks to the print screen everyone has the opportunity to share the data of the messages received without your consent. As organizations invest heavily in strengthening their security solutions to deal with new super threats, they are still falling into conflict with the most basic form of physical shoulder surfing hack. Looking at a strange phone. A predominant kind of simplistic hacking and a risk caused by Laisse's righteous attitude toward screens. This so-called visual hacking takes place every day in airport train offices and anywhere else we access a device resulting in the theft of sensitive data.

It is perfectly common to read as you watch people in your line of sight writing emails composing texts and surfing the internet. It's watching people. Anything you say publicly on a blog in a Facebook post or in a tweet can be shared far beyond the audience you imagined and this wreaks havoc on countless occasions people are more cautious about having a permanent record than they shared Mark Zuckerberg wrote in a post announcing the change of platforms toward prioritizing closed groups and other private communications. In addition, many groups reinforce privacy through standards and etiquette, but one thing challenges all this screenshots. Sharing screenshots has become a normal part of our digital behavior. Formerly private or semi-private messages circulate online, amusing us and provoking drama. There are entire online subcommunities dedicated to private drama made public through screenshots; Facebook groups like me are just a simple moth to the garbage fire and ready a shameful marriage or subreddits like r/texts are built into screenshots of silly exchanges and ridiculous arguments. The popularity of shared screenshots reflects our sphere slow privacy.

As much as we try to maintain privacy in personal communications what the recipients of our data and messages do with our information is largely out of our hands. On a smaller scale sharing with someone even someone you trust can backfire spectacularly; an investigation revealed that texts and photos of Jeff Bezos with girlfriend Lauren Sanchez were compromised by Sanchez herself when she shared screenshots with her brother. The most tech savvy could write code to bypass the anti-screen capture features but there's also an easy, low-tech solution just take a picture of one screen with another screen. How to share files online safely and finally bring secure messages to the masses? It is a simple question that requires a simple answer. But maybe it's not as complicated as you think. A Stealth way to block spying and prying eyes.

There are many reasons to use 2Mess to share with friends disappearing messages and images. It's also a great way to share something with people you want to see, but not with the whole world. The security landscape is becoming more complex as types of threats proliferate. Just because it looks so basic and low-tech don't ignore visual hacking. It's a threat that can be countered.

The Stealth Mode of Turning on and off screens, turns off and password-protects computers and mobile devices when they are not in use with visual perception (establishment of visual contact) wherever they are. A fairly simple software alternative to privacy screens that prevent visual hackers from having access to the information displayed on the monitor.

Recognizing the growing need to protect clandestine listening communication systems. We want a more private Internet. We want to protect Screen shot too. We do not have large security measures such as theft or espionage precautions and standards to determine when it is appropriate to share an image of a conversation with another person.

There are some articles and patent documents that describe methods, systems, devices, and filters for protection of display and printing screens, but none of these documents describe the invention proposed herein. Among these documents, the following can be highlighted:

Patent document US20200081527, GAZE-DEPENDENT DISPLAY ENCRYPTION, aspects of the subject technology are related to the eye-dependent visual encryption of electronic device screens. Each display frame that is displayed on the display of the electronic device may include a clear display region around the location of the user's gaze and an obscured region outside the clear display region. In this way, only the screen content that the user is actively viewing is recognizable and understandable and an observer, such as an unwanted observer looking over the user's shoulder, cannot understand what is displayed. The obscured region of each display frame may be generated such that the overall appearance and structure of that region remain unchanged, but the content is unintelligible. In this way, the user's visual experience is not interrupted or distracted by the visual encryption and the observer's eye is not guided to the clear display region by the visual encryption;

The scientific article OUTSMARTING DEEP FAKES: RESEARCHERS DEVISE AN AI-DRIVEN IMAGING SYSTEM THAT PROTECTS AUTHENTICITY, de NYU Tandon, which describes the state of the art forensic image authentication technology developed only for law enforcement agencies; and

The FiA64 product, FORENSIC IMAGE AUTHENTICATION, which discloses a New Technology and presents a neurocognitive perspective on encryption. It is a comprehensive software with analysis tools designed for forensic analysis and digital image authentication. This extensive toolkit allows the user to investigate the evidence and detect possible traces of tampering or other types of inconsistencies.

### BRIEF DESCRIPTION OF THE FIGURES

The following is a reference to the FIGURE that accompanies this description, for a better understanding and illustration of it, where it is seen:

FIG. 1 shows a schematic of the smart media protocol method, a media ID for responsibility and authentication, and device for security and privacy in the use of screen devices, to make message data more private, object of this invention.

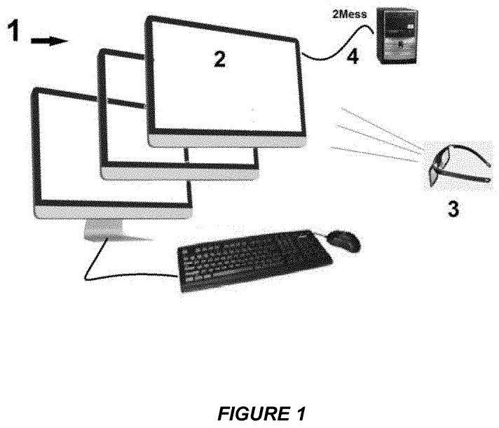

### DETAILED DESCRIPTION OF THE EMBODIMENTS

The smart media protocol method, a media ID for responsibility and authentication, and device for security and privacy in the use of screen devices, to make message data more private, object of this invention, is the use of Private Screen Filters with an encryption polarization mode through a tokenization system designed to be arbitrary information by adding a second layer of encryption, where the interface image information fuses from layers. Being a privacy shield for people who work with sensitive data. Such that information can only be viewed on a screen using the encryption polarization filter so that anyone attempting to obtain screen loggers or peek aside will only see a screen with no information set. Where with the use of polarized crypto-polarized lenses (3) by the user is able to retain additional freeform data that can be attached while the image is being created the intensity of the light reaching the image element and the overall contrast of the image transmitted to the screen can also be controlled.

The Privacy Filter (2) is a panel or filter placed on a screen as a superimposed imaging element. Polarizing filters can be viewed as a grid that only allows light waves to pass in a given orientation. The polarizing filters on a screen are aligned so that their grids are in the same direction. The light passing through the first filter is crypto-polarized. Crypto-polarized lenses (3) have a special filter that acts as a cryptographic key. To turn an encrypted image into a flat image after the image passes through the personal key filter.

Thus, to view birefringent anisotropic the user must be equipped with a polarizer positioned in the light path (a second polarizer) placed in the optical path or additional smart glasses.

The polarizing screen filters aligned with the smart glasses, combined with the cryptographic algorithm for transformation and processing of the oriented images in different directions followed by a private key alignment screen filter. For all this to work, the method encodes the data in such a way as to allow encryption with a cell phone camera and an application functioning as an electronic self-collimator tool for optical testing, for measuring angular displacements of specular reflective surfaces and the precise angular alignment of the screen and polarizing the filter parts, resulting in the ideal measurement solution in relation to the resolution of the angle and measurement range that is easily found.

The method also introduces a Smart Media protocol, which is a media ID for responsibility and authentication, which empowers vulnerable people against misinformation deepfake political announcements and publicity disseminated as informational media, and a digital signature of the media creator/publisher for media consumers using distributed accounting technology as a blockchain service to track digital media, traceability and responsibility.

The basic theory is related to the number of points within a mathematical equation that are necessary to reveal what the equation is (raster or bitmap graphs). How do pirates share a treasure map if they don't trust each other? The problem they often have is how to share a secret treasure map. This is the basics of a new method that allows the distribution of shares without revealing the original data. It provides us with a way to create keyless encryption. So, let's say we have two pirates, and they need to set the course to get to the buried treasure. Now they remember the Pirate School and remember that each must place a marker along the route so that both markers are in a line from the starting point to the treasure. They can then gather and place their marker in each place and then they follow the route and find the treasure.

The fundamental idea behind data encoding and decoding is an algorithm that encodes the collected information as a stream of bytes and then modulates it as signal ‘1’ and ‘0’. On LCD screens each pixel features a combination of RGB colors that produce the required composite color. In the proposed modulation the RGB color component of each pixel is slightly changed. A display device changes the pixel values to encode the data. Encode sensitive information as a stream of bytes and then modulate it on the screen by making small changes to its brightness invisible to the human eye to secretly modulate binary information into Morse code-like patterns decoded by the filter.

When a compromised monitor is recorded by a screen logger an attacker cannot access and decode through image processing techniques.

Thus there will be a whole category of products that deal with adding encryption to existing visual interfaces. With 2Mess it is the first step towards the vision of this future. The message does not necessarily need to be confused. In a simpler way be visible when the user is right in front of the phone. Users still have the same email address they are still contacting their customers in the same way they don't need to start doing abnormal things that get in the way of their workflows.

The basic concept is to use facial recognition identity authentication while preventing fraud by protecting public safety and improving the customer experience. Display images only after receiving visual attention feedback effectively through eye tracking. for messenger users who handle sensitive data or anyone who wants to keep what is on their phone or laptop hidden these privacy screens keep customer details and personal information away from prying eyes allowing anyone directly in front of the monitor to see this clearly.

Encryption with spatial argument: a novice concept of encrypting messages. Using AR as a private key. This is where the concept of image augmentation comes in handy. Image augmentation synthetically modifies the images to emulate the different scenarios of how humans can view the image interface. Possible increases include:

Virtual and real background with counter-shaded and encrypted. Combining digital interfaces with similarities around. It changes when needed to look like the local background. Active AR cryptographic messages can use both dynamic color change and backlight. The methods used are the combination of the color and the background pattern and the interruption of the contours. Diffuse lighting accessories, according to the local environment. It involves an algorithm that refines your behavior in response to positive or negative feedback. The user clicks on a button or hinders feedback;

Image concealment. Suitable pixels to harmonize with the environment (complementary images/pixels/shadows) causing disruptive camouflage, background blending and counter-shading. Additional visual information (pirate map AR two peaks; information in multiple channels;

The transparent screen allows users to “split” the digital content. Provides additional visual information to the brain. Multiplexing (or muxing) is a way of sending multiple signals or flows of information through a communication link at the same time in the form of a single complex signal; the receiver retrieves the separate signals, a process called demultiplexing (or demuxing);

Multiplexing is the simultaneous sending of multiple information streams in a communication medium as a single complex signal that is then retrieved at the receiving end.

A disruptive visual pattern, for encryption as a camouflage used to make images less visible. He uses patterns to disguise the information in the image. This camouflage is designed to obscure the visual lines of the image and is used along with padding, covers and decals.

The purpose of the patterns is to avoid visual observation by causing a visual mess (and to a lesser extent the photograph), which would later allow the reproduction of the screen or monitor.

It can work independently or in conjunction with other encryption tools. In this tool, the facial recognition authentication and an eye-tracking system acts as the encryption key, which allows users to view interfaces to control access to data in a very granular way, unlocking information only for people or applications who wish to have access to that information. The mess introduces an encrypted “standardized clutter” interface tool as part of the security service platform. Help users incorporate encryption easily into screens This can be as simple as individual communication in an encrypted messaging application, but it can be more complex at the application layer, depending on how it's configured It's very powerful to have a user make this decision, but that's not the only use case. There are many different ways to enable those who have visual access to the data.

It is really powerful for a user to make this decision, but this is not the only use case. There are many different ways to enable those who gain visual access to data. Regardless of how this is implemented, the user never needs to understand encryption or even know that encryption is at stake in the application. All they need to do is install a polarizing filter or use polarized sunglasses to view your screen, enter a password as they always did (or replace the passwords with, for example, face recognition), and then software handles the complex parts under the hood using encryption algorithms, is able to adjust the interface. Enabled detection and tracking technologies to intelligently understand on-screen user observation.

Enabled detection and tracking technologies to intelligently understand screen users' observation. By choosing certain phase values for neighboring pixels, similar to focusing light with a lens, the light waves from these pixels can constructively interfere with certain positions in space. In these positions, the light from all these pixels adds up to generate a bright spot in space—a pixel.

A layer mesh by adding or subtracting bitmap image. Different areas that contribute to visual perception. Each processes a unique aspect of visual information. These areas are like a cinema with multiple screens, but here each screen shows a different attribute of the same film—some just the movement, others the colors etc. Involved in the formation of conscious representations of the identity of objects, integrating image relations between AR and our environment.

Create an image to be visualized using post-image, a visual illusion in which retinal impressions persist after removal of a stimulus, which is believed to be caused by continuous activation of the visual system. The post-image can be positive, corresponding in color or brightness to the original image, or negative, being less bright or complementary colors to the original. A common residual image is the point of light that is seen after the camera flash is fired. Post-image is the most easily observed of the class of phenomena known as post-sensations or side effects. This solution gives the media content and creator a digital identity as a package.

The metadata stored by the database is saved permanently and cannot be changed. It can be added later, but you can't delete what's already there. This connection between the media itself and its creator/origin accessible on the blockchain is at the heart of what makes this solution different from everything that comes before it.

Public information about the media, stored on the blockchain, becomes available to the user. It protects the content from tampering and improves legitimacy by displaying what the creator intended. Once the fingerprint is attached to the digital media, this data cannot be exchanged for a forgery.

By uploading a media and storing its metadata/fingerprint in a database, the application can help identify a media using the power of data recognition, making it easy to reference the record on the blockchain and find the truth (presence of sound, videos, written text, and altered images with artificial intelligence). This also means that copycats will not be able to record false data related to that work.

A new important and dangerous phenomenon in AI: deepfakes. Deepfake technology allows anyone with a computer and an Internet connection to create realistic photos and videos of people saying and doing things they haven't actually said or done.

Due to the broad accessibility of the technology, this footage can be created by anyone: state-sponsored actors, political groups, lonely individuals.

However, the greatest threat is the potential for deepfakes to be used in political disinformation campaigns. It can be even more dangerous in developing countries where digital literacy is more limited. There you could actually impact how society would react.

The emergence of deepfakes will make it increasingly difficult for the public to distinguish between what is real and what is false. The recent rise in fake news has raised fears that we are entering a “post-truth” world. In a world where seeing is no longer believing.

Over time, this will prevent people from attempting to falsify the media or campaign for disinformation. In reality, however, technology will only be part of the solution. This is because deepfakes are likely to improve faster than detection methods.

Promoting the shared global use of Digital Media Signature facilitates international cooperation in promoting and supporting the use of anti-deepfake technologies. To detect altered media that could generate political misinformation, corporate sabotage, or cyberbullying.

A proactive action against disinformation, empowering the vulnerable population against disinformation. With each passing day society spends more time online, it's time to clean the room for a better life. Prevention and reliable information are the best protection against deepfake.

In this way, as described above, by the advantages and characteristics of configuration and operation, described above, it can be clearly noted that the smart media protocol method, a media ID for responsibility and authentication, and device for security and privacy in the use of screen devices, to make message data more private is a new system for the State of the Art, which has unprecedented conditions of innovation, inventive step and industrialization, which make it deserve the patent of invention registration.

1. A smart media protocol method, a media ID for responsibility and authentication for security and privacy in the use of screen devices, to make message data more private, comprising: using private screen filters with an encryption polarization mode through a tokenization system designed to be arbitrary information by adding a second layer of encryption, wherein the interface image information fuses from layers, forming a privacy shield for people working with sensitive data; wherein the information only presenting a screen with no information defined for third parties; and wherein with the use of polarized crypto-polarized lenses by the user is able to retain additional data freely that can be attached while the image being created the intensity of the light that reaches the image element and the overall contrast of the image transmitted to the screen can also be controlled.

2. The method of claim 1, further comprising a cryptographic algorithm for transformation and processing of the oriented images in different directions followed by an alignment private key screen filter being an algorithm that encodes the collected information as a flow of bytes and then modulates it as signal ‘1’ and ‘0’, increasing the encryption, taking into account brain activity and its visual perception the visual information does not exist until it is observed; wherein said cryptographic algorithm transforms and processes the oriented images in different directions followed by an alignment private key screen filter, which make up and determine the security and privacy device, and are always complementary to each other together form visual information, encoding the data as an optical test tool electronic self-collimator, for measuring angular shifts of specular reflective surfaces and the precise angular alignment of the screen and polarizing the pieces of the filter.

3. The method of claim 1, further comprising introducing a Smart Media protocol, comprising is a media ID for responsibility and authentication, which empowers vulnerable people against misinformation, deepfake political advertisements and advertising disclosed as informational media, and a digital signature of the media creator/publisher for media consumers using distributed accounting technology as a blockchain service to track digital media, traceability and responsibility.

4. The method of claim 1, further comprising, applying, alone or in combination with other methods, information about health warnings to avoid health problems through a viewer positioned at optimal distance from the screen.

5. The method of claim 1, wherein the Privacy Filter is a panel or filter placed on a screen as a superimposed imaging element, wherein the polarizing filters can be viewed as a grid that only allows the passage of light waves in a determined orientation; and wherein the polarizing filters on a screen are aligned so that their grids are in the same direction, the light passing through the first filter is cryptotopolarized.

6. The method of claim 1, wherein the crypto-polarized lenses have a special filter that functions as a cryptographic key, which transform an encrypted image into a flat image after the image passes through the personal key filter.

7. The method of claim 2, further comprising introducing a Smart Media protocol, which is a media ID for responsibility and authentication, which empowers vulnerable people against misinformation, deepfake political advertisements and advertising disclosed as informational media, and a digital signature of the media creator/publisher for media consumers using distributed accounting technology as a blockchain service to track digital media, traceability and responsibility.

8. The method of claim 2, further comprising applying, alone or in combination with other methods, information about health warnings to avoid health problems through a viewer positioned at optimal distance from the screen.

9. A device for security and privacy in the use of screen devices, to make message data more private, device to be used with the Smart Media Protocol Method A media ID for responsibility and authentication for security and privacy in the use of screen devices, to make message data more private, the device comprising: Private Screen Filters with an encryption polarization mode through a tokenization system designed to be an information arbitrary by adding a second layer of encryption, wherein the interface image information fuses from layers, forming a privacy shield for people working with sensitive data; where the information only presenting a screen with no information defined for third parties; and wherein with the use of polarized crypto-polarized lenses by the user is able to retain additional data freely that can be attached while the image being created is the intensity of the light that reaches the image element and the contrast of the image transmitted to the screen can also be controlled.

10. The device of claim 9, wherein the Privacy Filter is a panel or filter placed on a screen as a superimposed imaging element, where the polarizing filters can be viewed as a grid that only allows the passage of light waves in a determined orientation; where the polarizing filters on a screen are aligned so that their grids are in the same direction, the light passing through the first filter is cryptotopolarized.

11. The device of claim 9, wherein the crypto-polarized lenses have a special filter that functions as a cryptographic key, which transform an encrypted image into a flat image after the image passes through the personal key filter.
